(19) United States
(12) Patent Application Publication
(10) Pub. No.: US 2022/0022469 A1
(43) Pub. Date: Jan. 27, 2022

(54) U-SHAPED BURGER BREAD AND MANUFACTURING METHOD THEREOF

(71) Applicant: Hae-Yong CHOI, Seoul (KR)

(72) Inventor: Hae-Yong CHOI, Seoul (KR)

(21) Appl. No.: 17/339,147

(22) Filed: Jun. 4, 2021

(30) Foreign Application Priority Data
Jun. 4, 2020 (KR) 2020-0067502

(51) Int. Cl. A21D 13/32; A21D 13/047; A21C 11/00

(52) U.S. Cl. CPC A21D 13/32; A21C 11/00; A21D 13/047

(57) ABSTRACT

Disclosed are U-shaped burger bread and a manufacturing method for U-shaped burger bread. The U-shaped burger bread is characterized in that a receiving space is formed by an outside of the bread and three sides consisting of inner upper, rear, and lower surfaces, the receiving space is elongated in a longitudinal and one side thereof is opened, and contents of the burger such as meat, vegetables, and sauces are received into the receiving space with the opened one side, so that the contents are stably received into the bread in which the U shape is fixed and maintained and the contents are not in disorder when eating, the taste is maintained, and it is easy to be taken with one hand. The manufacturing method for the U-shaped burger bread is characterized in that the paste is secondarily fermented, aged, formed and baked in the reverse U-shaped molding frame to be fixed as the U-shaped bread.

### CROSS-REFERENCE TO RELATED APPLICATION

This application claims under 35 U.S.C. § 119(a) the benefit of Korean Patent Application No. 10-2020-0067502 filed on Jun. 4, 2020, the entire contents of which are incorporated herein by reference.

### BACKGROUND

### (a) Technical Field

The present invention relates to burger bread such as a hamburger, a cheese burger, a rice burger, and a vegeburger, and more particularly, to burger bread and a manufacturing method thereof in which a shape of bread is fixed to a U shape, the fixed U shape is elongated in a longitudinal direction, and one side thereof is opened.

### (b) Background Art

Due to the infection of virus such as Covid-19 pandemic which frequently spreads, public transportation is controlled, and gradually, drive-through in which individuals order meals on their vehicles, food trucks, and takeout-oriented roadside restaurants have been more important than multiple spaces such as restaurants where many people gather at the same time.

However, these foods to be supplied in a takeout manner need to be rapidly provided, so that cooking time should be fast, a customer to be received should easily take a meal in a vehicle, a flavor is maintained during moving, and a taste and a nutritional value should be good.

Particularly, a conventional burger such as a hamburger is a kind of sandwich where a patty flatly made by grinding beef is grilled or roasted directly on fire and sandwiched between breads with various vegetables.

In the conventional hamburger, the patty is roasted well to be well-done, mostly, circular burger bread is split in half, the insides thereof is warmly baked, and then the patty is placed on the lower side of the spilt bread, and vegetables such as lettuce, tomatoes, onions, and pickles are sequentially stacked thereon, and then the bread is covered thereon like a cover.

In more detail, as illustrated in FIG. 11A, circular bread having a diameter of about 10 cm to 12 cm is spilt into two parts and then contents including meats such as beef, chicken, ham and sausages, vegetables such as lettuce, pickles, tomatoes, cabbage-pickled kimchi, and pickles, sauces, ketchup, etc. are sequentially stacked therebetween at a height of about 6 cm to 10 cm.

Even during cooking, it takes about 8 minutes or more to provide the burger after the bread is vertically split to make two parts, the two parts of bread are warmly heated, the patty is separately cooked, the contents are stacked on the bread at a height of about 6 cm to 10 cm, and the upper bread is covered.

Further, during cooking, since the bread is two-split one by one, the patty and vegetables are stacked on the lower bread, the upper bread is covered, and then a pin is fixed to prevent the contents from falling down, a lot of providing time is required.

Particularly, in this cooking process, the insides of a pair of two-split pieces of bread are heated, the patty is roasted, ketchup and sauces are poured on the lower bread, and the contents of the burger such as the patty and vegetables, tomato, pickles, etc. are sequentially stacked again. However, in this process, it takes a lot of time and it is difficult to maintain the shape of the stacked contents.

Further, in the method of vertically stacking these contents, packaging is required again at takeout, and the shape of the burger is not preserved. In addition, since the burger is taken at home or offices, the contents and the sauces are pressed and spread, and thus the flavor and the taste are reduced.

In the conventional hamburger illustrated in FIG. 11A, there is a problem that since the size of the burger is large when the burger is taken in the vehicle or at offices or homes, the burger should be taken with two hands and the contents such as the patty, ketchup, sauces, vegetables, etc. are leaked and then fall down on the cloth and are easily stained and contaminated on hands or mouth.

Accordingly, in the conventional hamburger bread, there are problems that since the size of the bread is large and the height of the contents stacked between two pieces of bread is very large, the burger should to be taken with both hands. In addition, since the height of the bread is large, the shape of the bread is pressed during packaging, and thus, the taste decreases, and the sauces and the like are leaked and thus it is inconvenient to be eat, and the warmness of the bread is lowered during packaging and moving and thus the texture of food is rapidly lowered.

Further, since the burger will be ordered and served on the vehicle in a takeout order at drive-through shops or roadside restaurants, there is a need to reduce the waiting time for the vehicle in a confined space, and thus, there is a need to provide the burger faster by reducing the cooking time of the burger. In addition, the shape of the hamburger is required so that the shape of the provided burger is preserved, the flavor should be maintained, the burger can be easily taken with one hand while eating, and the contents are stably received and maintained when eating.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

An object of the present invention is to provide U-shaped burger bread and a manufacturing method thereof, in which the burger is provided faster than the related art by shortening the cooking time, the waiting time for the vehicle can reduced in a restricted space such as drive-through or takeout restaurants, the shape thereof is fixed and the flavor is maintained, the burger can be easily taken with one hand, and particularly, the contents thereof can be stably received and maintained.

According to an aspect of the present invention, there is provided U-shaped burger bread, wherein an outside of the bread consists of an upper surface, a rear surface, and a lower surface, and an inside of the bread consists of an inner upper surface, an inner rear surface, and an inner lower surface, so that the entire shape is formed in a thick U shape,

the inner upper, rear, and lower surfaces of the bread are formed in a U shape to form and fix a receiving space,

the shape of the U-shaped bread and the receiving space are elongated in a longitudinal direction and the receiving space elongated in the longitudinal direction has one opened side, and

contents of the burger such as meat, vegetables, and sauces are received into the receiving space with the three fixed sides and the one opened side.

In order to manufacture the U-shaped burger bread, the U-shaped burger bread is manufactured by forming and fixing the shape of the bread in a U shape including the steps of

adding, stirring, mixing, and kneading vegetable flour such as flour as a main ingredient, sugar, milk, salt, yeast, and water in a kneading bowl and aging and primarily fermenting a paste and removing gas in the paste primarily aged and fermented;

preparing a molding frame for forming and completing the U-shaped bread by forming the inside in a reverse U shape and a bar shape elongated in a longitudinal direction based on a cross-sectional shape to manufacture the U-shaped bread;

receiving a paste formed in a rectangular shape in the molding frame to seat the paste removed with the gas on the molding frame;

re-fermenting the paste received in the molding frame for 20 minutes to 40 minutes;

completing the U-shaped burger bread by putting and baking the molding frame received with the re-fermented paste in an oven at 150° C. to 190° C. for 20 minutes to 50 minutes; and

separating the completed U-shaped bread from the reverse U-shaped bread frame and cooling the U-shaped bread in a cooling net.

The inner surface of the completed U-shaped bread is heated by a heating device which is formed in a reverse U shape corresponding to the inner surface thereof.

In the molding frame for manufacturing the U-shaped bread, based on a cross-sectional shape, a reverse U shape is formed in an inner middle part, and expanding spaces for determining the thickness of the bread by considering the expansion of the bread when baking the bread are formed at left and right of the reverse U-shaped molding frame, and heat is introduced from the outside of the reverse U-shaped molding frame to form and bake the U-shaped burger bread.

According to the present invention, since the shape of the burger bread is formed in a U shape elongated in a longitudinal direction and fixed and one side is opened, the contents are stably received in the bread, the contents are not in disorder when eating, the taste is maintained, and the shape of the bread elongated in the longitudinal direction can be easily taken with one hand.

Further, since the U-shaped bread is elongated in the longitudinal direction to receive the contents, the burger is manufactured at a size suitable for a mouth size of an eater and easily held in a packaged state to be easily taken in vehicles, offices, or the like.

As illustrated in FIG. 11A, in the conventional hamburger, as a method in which one bread is split into two parts, two pieces of bread make a pair, and vegetables and a patty are sequentially stacked therebetween, the insides of the two pieces of bread are heated and the vegetables and the patty are sequentially and carefully stacked therebetween at about 8 cm, and as a result, it takes a lot of manufacturing and cooking time.

However, according to the present invention, as illustrated in FIG. 11B, only when the contents such as a patty, vegetables, and the like are simply received in sequence in the bread fixed in the U shape, the shape thereof is fixed and supported in three directions of an inner surface, i.e., a rear surface, an upper surface, and a lower surface of the U-shaped bread, and as a result, the cooking time of the burger can be shortened to ⅓ or more to enable rapid providing.

Further, in the conventional hamburger, the insides of two pieces of bread are heated in an oven, but according to the present invention, the insides of a plurality of U-shaped burgers are simultaneously heated at all time by placing the U-shaped burgers on a reverse U-shaped heating frame, so that the cooking time is shortened as much.

In the conventional hamburger, there is a problem that the contents such as a patty, ketchup, sauces, lettuce, etc. in the hamburger are leaked when eating and then easily stained on the hands or mouth and fall down on the cloth to be easily contaminated on the hands, the cloth, or the like.

However, according to the present invention, the bread itself is formed in the U shape and the rear, upper, and lower surfaces of the fixed bread support and protect the contents so as to prevent the problem.

In the related art, since an inner receiving space is not formed, there is a problem that the contents are pressed under pressure, the ketchup is permeated, and vegetables are deformed, and the texture of food is deteriorated.

Further, according to the present invention, since the bread itself is formed in a U shape and fixed, the burger is easily packaged and not deformed even during packaging and moving, and the shape of the U-shaped bread covers the contents, so that the flavor is preserved for a long time as much.

Therefore, according to the present invention, the cooking time is shortened as compared to the conventional hamburger and the shape is maintained during moving, the texture of food is maintained, the warmness is maintained, the taste is maintained, and the meats and the vegetables are rapidly and stably stacked in the formed U-shaped bread, so that the cooking time is also significantly shortened to ⅓ as compared to the related art.

It should be understood that the effects of the present invention are not limited to the effects described above, but include all effects that can be deduced from the detailed description of the present invention or configurations of the invention described in appended claims.

### BRIEF DESCRIPTION OF THE DRAWINGS

FIG. 1 is a diagram for describing U-shaped hamburger bread.

FIG. 2A is a diagram for describing a configuration of the U-shaped hamburger bread.

FIG. 2B is a diagram for describing a cross-sectional configuration of the U-shaped hamburger bread.

FIG. 3 is a diagram for describing a manufacturing process.

FIG. 4A is a diagram for describing a configuration of a U-shaped molding frame.

FIG. 4B is a diagram for describing a cross-sectional configuration of the U-shaped molding frame.

FIG. 5 is a diagram for describing that bread is formed in the molding frame.

FIG. 6A is a structure of an extrusion mold of the bread.

FIG. 6B is a diagram for describing cutting of the U-shaped bread.

FIG. 7A is a diagram for describing a molding frame to be used when the U-shaped bread is mass-produced.

FIG. 7B is a diagram for describing the U-shaped bread separated from the molding frame in FIG. 7A.

FIG. 8A is a diagram for describing U-shaped bread having a circular inner part.

FIG. 8B is a diagram for describing U-shaped bread having a rectangular inner part.

FIG. 8C is a diagram for describing U-shaped bread having a star-shaped inner part.

FIG. 9A is a diagram for describing a heater for an inner surface of the U-shaped bread.

FIG. 9B is a diagram for describing heating the inner surface of the U-shaped bread.

FIG. 10 is a diagram for describing cooking a patty.

FIG. 11A is a reference diagram of a conventional hamburger, and FIG. 11B is a reference diagram of a U-shaped burger of the present invention in comparison.

### DETAILED DESCRIPTION

Hereinafter, the present invention will be described in detail with reference to the accompanying drawings.

Types of hamburgers include a cheeseburger in which ham, meat, or cheese is put between burger breads, a rice burger in which a main material of the burger bread is replaced with rice instead of flour, a vegeburger in which beef is replaced with vegetables, etc. The present invention relates to burger bread to be applied to all existing burgers and is characterized by burger bread having a U shape.

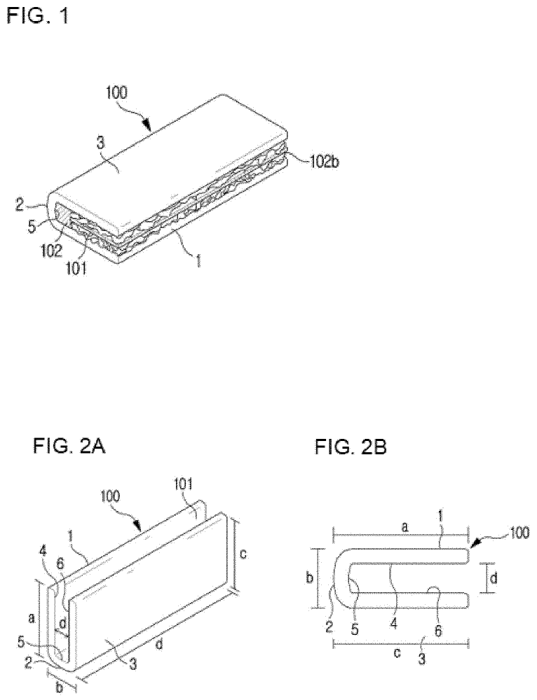

As the features of the U-shaped burger bread, as illustrated in FIGS. 1, 2A, and 2B, an upper surface 1, a lower surface 2, and a rear surface 2 are formed in a U shape to the outside of the bread, an inner upper surface 3, an inner rear surface 4, and an inner lower surface 5 are configured to the inside of the bread, and a receiving space d is formed between the inner upper surface 3 and the inner lower surface 5.

Accordingly, a thickness formed by the outer upper, rear, and lower surfaces 1, 2, and 3 configuring an outer surface of the bread and the inner upper, rear, and lower surfaces 4, 5, and 6 forming an inner surface of the bread becomes a thickness of the bread.

That is, three directions formed by the outer upper, rear, and lower surfaces 1, 2, and 3 and the inner upper, rear, and lower surfaces 4, 5, and 6 are fixed and elongated in a longitudinal direction, and one side, that is, the receiving space d is opened with the outside.

As illustrated in FIGS. 1 and 2A, such a U-shaped burger bread has a length e elongated in the longitudinal direction, one surface of the bread is opened in the longitudinal direction, and the receiving space d is formed in the longitudinal direction in the U-shaped inside.

A manufacturing method of the U-shaped burger bread is characterized in that the bread is secondarily fermented, aged, molded and baked in a U-shaped molding frame 200 so that the U shape is fixed.

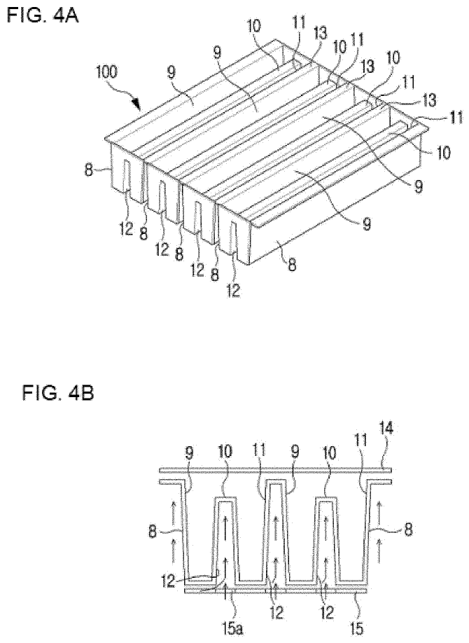

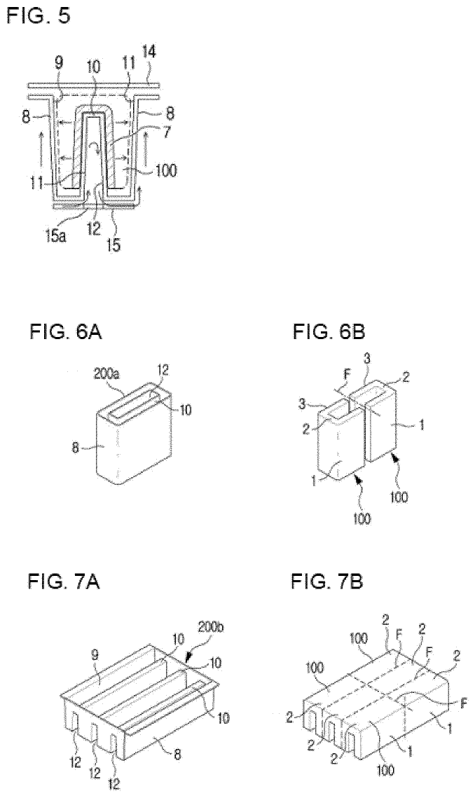

That is, as illustrated in FIGS. 4A and 4B and FIGS. 7A and 7B, a middle part is formed in a reverse U shape to be configured in a W shape, and as illustrated in FIG. 5, in a molding frame where the middle part protrudes in a reverse U shape, the bread rises in both left and right directions and expands, so that the bread 100 is formed in a U shape within an expanding space range of a left inner surface 9 and a right inner surface 11 of the molding frame 200. This shape is formed to be elongated in the longitudinal direction and fixed and baked in the molding frame 200.

This will be described in detail with reference to the accompanying drawings.

The U shape or U form expressed in the present invention means that the shape of the bread is formed and fixed in a U-like shape in which the upper surface 1, the rear surface 2, and the lower surface 3 are included, one direction thereof is opened, and a space is formed in the inside thereof, and such a shape is elongated in the longitudinal direction and opened. The shape is not limited to the U shape, but may include all burger breads having U-like shapes.

As illustrated in FIGS. 1 and 2B, based on a cross-sectional structure, the upper surface 1, the rear surface 2, and the lower surface 3 of the bread are formed in the U shape as the outside of the bread and the inner upper surface 4, the inner rear surface 5, and the inner lower surface 6 are formed in the U shape as the inside of the bread, so that a difference in U shape between the outside and the inside determines the thickness of the bread.

Further, a height d of the rear surface 5 in the inside of the U-shaped bread becomes the receiving space d in which the contents 101 are received. In the receiving space d, various materials such as meats, vegetables, etc. may be received as the contents 101 of the burger according to a menu.

In the contents 101, as a meat content 102, animal foods such as beef, pork, sausage, chicken, tuna, shrimp, cheese, eggs, vegetable meats, fish meats, and fish cakes, and as a vegetable content 102b, vegetable foods such as lettuce, kimchi, tomato, onion, pickles, burdock, etc. are variously received.

In the contents 101, as illustrated in FIG. 1, the meat content 102 is elongated in a rectangular or circular shape and stacked on the inner rear surface 5 of the bread, the vegetable content 102b is stacked on the front end thereof, and cheese and sauces may be added therebetween if necessary. The receiving form and order of the contents 101 may be sequentially received with various shapes according to a menu.

Such a U-shaped burger bread is manufactured by fixing and molding the U shape as follows.

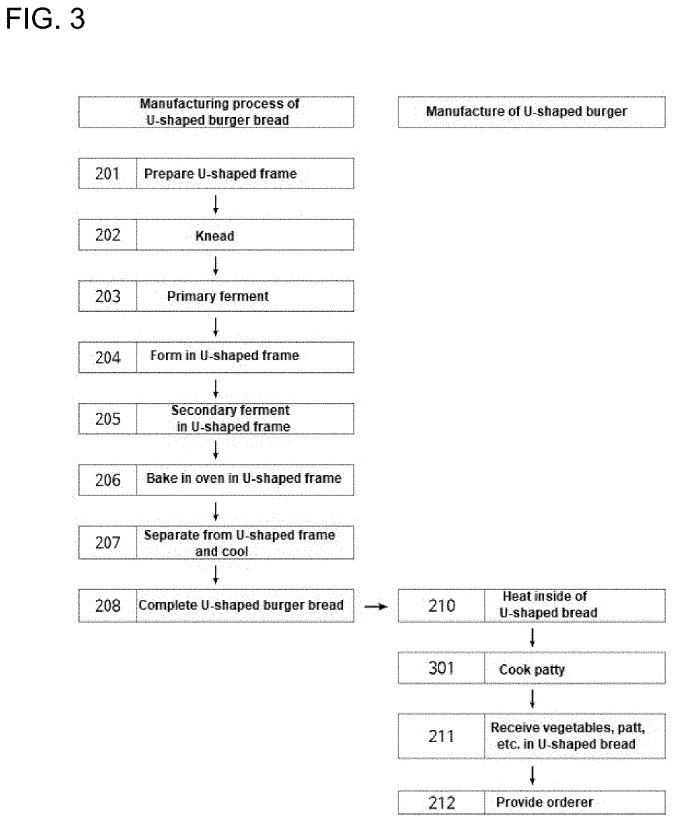

As illustrated in FIG. 3, the U-shaped burger bread is manufactured by steps of preparing a U-shaped molding frame, kneading a paste 7, primary fermenting, forming the paste 7 for putting in the U-shaped molding frame, secondary fermenting in the U-shaped molding frame, oven-baking in the U-shaped molding frame, and separating the U-shaped bread from the U-shaped molding frame.

The U-shaped bread formed and fixed as such is completed by heating the inner surfaces thereof, or stacking the contents 101 on the receiving space d of the U-shaped bread heated through secondary processing after spreading butter and eggs.

This process will be described in detail for each step.

### Step 1: Preparing U-Shaped Molding Frame 200

As illustrated in FIGS. 4A and 4B, the U-shaped molding frame 200 is configured in a W shape in which one middle part has a reverse U shape or a plurality of middle parts are adjacent to each other at left and right.

As illustrated in FIG. 5, in such a molding frame 200, the middle part protrudes in the reverse U shape, and the left inner surface 9 and the right inner surface 11 are formed on left and right inner portions thereof to determine the bread thickness in a process of raising, expanding, and baking the bread.

Such a shape is prepared in the molding frame 200 elongated in the longitudinal direction.

As illustrated in FIG. 4B, in such a U-shaped molding frame 200, heat is introduced from the outer surface of the reverse U shape to form and bake the U-shaped burger bread therein.

In this case, as illustrated in FIG. 5, a support 15 capable of adjusting the heat is provided below the molding frame 200 to adjust the heat.

That is, when the heat is too high, the surface of the bread of the corresponding portion is baked and may not be soft. In this case, a heat through groove 15a through which an appropriate amount of heat passes is configured in the support 15 to adjust the through amount of the heat.

Further, an internal temperature may be adjusted by using a cover 14.

### Step 2: Kneading

Based on parts by weight, 100 parts by weight of sieved medium flour or strong flour or mixed flour of medium flour and strong flour, 10 parts by weight of sugar, 10 parts by weight of eggs, 10 parts by weight of room-temperature butter, warm milk of ½ of the weight of the flour, 1.2 parts by weight of salt, and 1 to 2 parts by weight of dry yeast are prepared. The salt, sugar, and yeast are put in the flour separately so as not to be in direct contact, warmed milk and eggs are mixed, and then the flour is kneaded, and added and kneaded with butter, and then the paste 7 is rounded in a loaf and kneaded.

The example is an embodiment, and the parts by weight may be increased or decreased depending on the purpose of manufacture, and the types of material, etc. may be reduced and added.

The manufacturing process of steps 2 and 3 is just the manufacturing process, but are not limited.

### Step 3: Unit Weight per Bread and Primary Fermentation

A plastic wrap or the like is covered on the paste 7 so that moisture is not removed, and the paste 7 is placed on a warm water bowl and fermented for about 20 to 40 minutes to rise about twice. Thereafter, the cover is taken off and the paste 7 is roundly separated by unit weight per U burger bread and aged for about 10 to 20 minutes so as to further rise.

### Step 4: Forming Rectangular Paste for Forming U Shape in Molding Frame

In the primary fermenting, the U burger is aged by weight unit per burger and this aging unit is milled in a rectangular form to extract the air in the paste 7.

The paste 7 is formed in a rectangular shape to be close to a horizontal length of a+b+c illustrated in FIG. 2B and a vertical length of e. In this step, if necessary, external ingredients such as sesame or raisins may be added.

### Step 5: Secondary Fermenting in U-Shaped Molding Frame

As illustrated in FIG. 5, the rectangular paste 7 manufactured in step 4 is secondarily fermented while the center of the formed paste 7 is placed on the inner upper surface 10 of the molding frame, both surfaces of the paste 7 are stretched on the inner left and right surfaces 9 and 11 of the molding frame 200, water is heated for 1 to 2 minutes, the U-shaped molding frame 200 is placed thereon, and the plastic wrap or the cover is closed.

### Step 6

The paste 7 fermented in the U-shaped molding frame 200 is baked at 160 to 190° C. for about 15 to 30 minutes. In this step, an egg mixture or butter may be spread and baked on the surface of the paste 7 as needed.

### Step 7: Separating Bread from Molding Frame 200

The U-shaped bread baked in the oven is separated from the U-shaped frame and cooled to fix the shape of the bread to the U shape.

### Step 8: Heating Inner Surface of U-Shaped Bread

When the U-shaped burger bread 100 is placed on a heater 17 as illustrated in FIG. 9A, the insides of the lower surface 4, the rear surface 5, and the upper surface 6 in the bread are evenly baked.

### Step 9: Stacking Contents 101 in U-Shaped Bread

As such, the U-shaped bread of which the inner surface is baked is provided by adding the contents 101 such as a meat patty, vegetables, sauces, etc. into the U shape.

### EXAMPLE 2

A manufacturing method of U-shaped burger bread made from rice flour is as follows.

Step 1: Based on 100 parts by weight, 100 parts by weight of rice flour, 1 to 2 parts by weight of instant yeast, 1 part by weight of salt, 6 to 7 parts by weight of sugar, 5 parts by weight of butter, 1/6 to 1/5 of eggs, 80 ml to 85 ml of water, and 16 to 20 parts by weight of additives such as raisin, walnut, pine nut, and chestnut if necessary may be added. The kinds and amounts of the ingredients may be increased or decreased.

Step 2: Water is heated, the rice flour is poured, and yeast, sugar, and salt are separately put, and then the mixture is kneaded in a kneader at a low speed to make a loaf, and then added with butter, and rotated and kneaded at a middle speed until the butter is not shown.

Step 3: In an intermediate fermentation step, an intermediate fermentation time is about 5 to 10 minutes.

Thereafter, the manufacturing method is the same as that in Example 1.

That is, step 4: forming a rectangular paste 7 for forming a U shape in the molding frame 200,

Step 5: secondary fermenting in the U-shaped molding frame 200, and

Step 6: baking the paste in the U-shaped molding frame 200 in the oven.

However, in this step, it is preferred to be baked in a 160° C. oven for 20 to 30 minutes.

Step 7: The bread is separated from the U-shaped molding frame 200 and cooled in a cooling net.

The manufacturing method of the present invention is characterized in that the U-shaped molding frame 200 is prepared, the kneading of the paste 7 and the primary fermentation are performed, and then the secondary fermentation in the molding frame 200, the baking in the molding frame 200, etc. are performed, so that the shape of the bread is formed in the U shape and fixed in the U-shaped molding frame 200.

The manufacturing method of the present invention may be applied to all vegetable flours which are edible as foods, such as mungbean flour, soybean flour, corn flour, sorghum flour, sweet potato flour, potato flour, cauliflower flour or coconut flour rated as alternative flour, tiger nut flour, banana flour, and mixed flour of the listed flours.

An appropriate amount of rice flour may be mixed and used in the vegetable flour. However, due to the characteristics of the materials, the number of fermenting times may be reduced and the baking temperature and time in the oven may be appropriately increased or decreased. However, the forming of the rectangular paste 7 for forming the U shape in the molding frame, the secondary fermenting in the U-shaped molding frame 200, the baking of the paste of the U-shaped molding frame 200 in the oven, and the separating of the bread from the U-shaped molding frame 200 are the same.

A preferred example of the U-shaped burger bread is configured as illustrated in FIG. 1 and a detailed embodiment is formed as follows.

| | |
|---|---|
| a: 6 cm | b: 5 cm |
| d: 3 cm | c: 10 cm. |

The patty included in the bread is filled in the receiving space d of the inner rear surface of the bread with a size of 3 cm×2 cm×10 cm as illustrated in FIG. 1. The remaining receiving space d of 3 cm×4 cm×10 cm received with the patty becomes a receiving space of vegetables, cheese, etc.

A total volume of the bread of the present invention is 300 mm³ having height×width of 6 cm×5 cm and a length of 10 cm. A brand hamburger to be compared has a size of the bread of circular 8 cm×height 6 cm and a volume of 4²×3.14×6=301 mm³. The volumes of the present invention and the brand hamburger to be compared are almost the same as each other.

Like the embodiment, the shape of the bread is fixed to the U shape, and the receiving space d and the shape of the bread are formed with a length of twice more than the width and elongated in a longitudinal direction.

The volume of the contents such as a patty, etc. in the inside is the same level.

The shape of a hamburger patty 102a to be applied to the present invention may be formed and used in a circular or rectangular long bar according to the inside of the U-shaped bread.

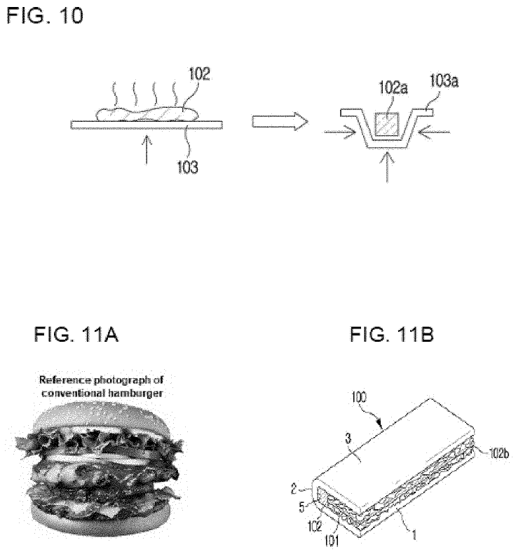

The long bar-shaped patty 102a may be heated in three directions of a U-shaped pan 103a as illustrated in FIG. 10, while the hamburger to be compared is heated only in one direction from only the bottom as illustrated in FIG. 10A, so that the baking time becomes 3 times. Accordingly, the cooking time of the present invention is reduced to ⅓ as compared with the cooking time of the conventional burger.

The hamburger bread to be compared is split into two parts and the insides of the two pieces of bread are heated, but only when the U-shaped burger bread of the present invention is placed on a reverse U-shaped heater 300 as illustrated in FIGS. 9A and 9B, both left and right surfaces are heated at the same time, and the cooking time is shortened to ½ or less.

In the hamburger to be compared, since a patty, lettuce, pickles and a patty are sequentially stacked on the circular lower bread, it takes a lot of time. Particularly, since the contents 101 are unstably maintained, a load time is taken. However, in the present invention, the bread is fixed and the patty and vegetables are sequentially stacked in the receiving space d between the stable U-shaped breads to be stably received, and the U-shaped structure of the receiving space d covers the received contents 101 to stably and rapidly receive the contents 101.

Such a U-shaped burger is compared with a brand burger MGB as follows.

TABLE 1

| | U-burger | Brand burger | |
|---|---|---|---|
| | (present | (burger to be | |
| | invention) | compared) | |
| Total volume | 6 × 5 × 10 cm = | 4² π × 6 = 301 mm³ | Equal volume |
| of bread | 300 mm³ | | |
| Number of | One U-shaped | Two upper and | |
| baking bread | bread | lower pieces of | |
| | | bread | |
| Bread heating | 20 sec per one | 50 sec × 2 = 100 sec | |
| time | | | |
| Patty cooking | 60 sec | 300 sec | |
| time | | | |
| Stacking time | Average 10 sec | Average 30 sec | |
| of contents | | | |
| (101) | | | |
| Total cooking | 120 sec | 430 sec | |
| time | (about 2 min) | (about 7 min) | |

For this reason, as shown in Table 1, in the U-shaped burger bread structure, it takes only 120 seconds (2 minutes) to make one burger, but in the hamburger to be compared, 420 seconds (about 7 minutes) is required. That is, in the U-shaped burger of the present invention, since the manufacturing time is shortened to ⅓, the customer's order may be accepted as fast as possible.

In the embodiment of the U-shaped burger bread of the present invention, bar-shaped bread with width 6 cm×height 5 cm×length 10 cm may be taken by one hand, and the length is increased to 15 to 20 cm and the width and height sizes may be decreased so much.

As illustrated in FIGS. 2A, 8, 9, and 10, there is an advantage that the U-shaped burger bread is manufactured to be elongated and may be cut and provided at an appropriate length.

Further, according to the present invention, in the manufacturing process, the outer surface or the inner surface of the U shape of the bread is spread with the egg mixture, butter, etc. and baked, so as to provide crispy and flavorful burgers.

Such a U-shaped burger bread 101 may be manufactured in various forms.

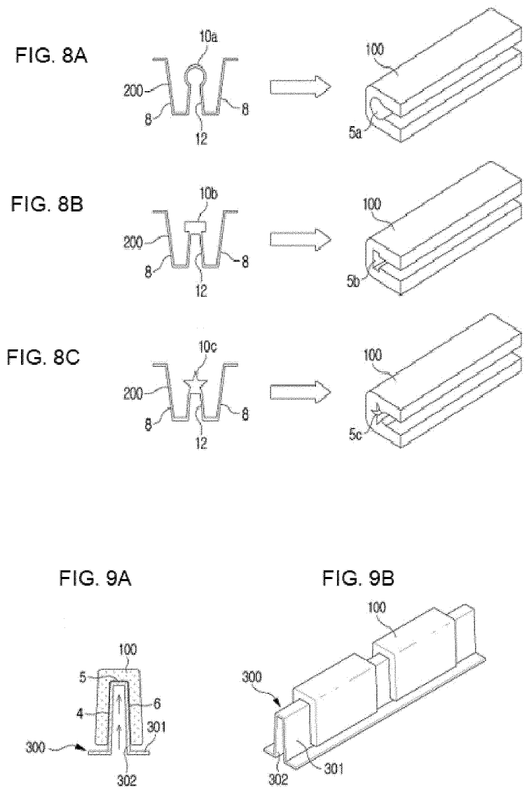

As illustrated in FIG. 8A, the inner upper surface 10a of the U-shaped molding frame 200 is formed in a circular shape 10a. Such a circular frame 10a may make the shape of the inner rear surface 5 of the U-shaped burger bread 101 as the circular shape 5a.

The meat content 102 such as sausages, patties, and fish cake received in the circular shape 5a is formed in a circular shape to be received and provided in the circular shape 5a.

Similarly, a rectangular shape 10b as illustrated in FIG. 9B and a star shape 10c as illustrated in FIG. 9C are applied in the same manner, and the inner rear surfaces 5b and 5c of the U-shaped bread are also formed in the same shapes, respectively, and the meat content 102 received therein is received in the same shape.

That is, in the present invention, the inner shape of the U shape may be variously formed.

A plurality of pieces of U-shaped burger bread manufactured by the manufacturing process may be simultaneously heated on the heater 300 as illustrated in FIG. 9B. Such a heater 300 may immediately heat three surfaces of the upper, rear, and lower surfaces 4, 5, and 6 of the U-shaped burger bread 100 as illustrated in FIG. 9A by adding a device of supplying electric heat, gas heat, etc. to the inner surface 302 of the heater 300 or placing the heater 300 on a cooking frying pan without a heating device. This quick internal heating is also enabled because the form of the burger bread is U-shaped.

Further, such a U-shaped burger structure may strength a flavor and a taste because the inner surface of the U-shaped burger is spread with the egg mixture and butter to be secondarily processed more crisply when manufacturing in the U-shaped molding frame.

Accordingly, since the U-shaped burger can be rapidly provided because of a ⅓ faster cooking time than the related art, it is very advantageous for reducing the waiting time for vehicles in drive-through takeaways and reducing the waiting time for customers such as food trucks and simple restaurants of subways, etc.

Further, the U-shaped burger has a small area of upper, lower, left, and right shapes according to a mouth size of an eating person as illustrated in FIGS. 1, 2A, and 2B, but has an elongated bar shape, so that the packaging is easy and the packaged bread has a good shape for eating with one hand.

Further, in the manufacturing method of the U-shaped burger bread, the U-shape bread may be provided by interlocking the U-shaped bread by an O-shaped molding frame 200a as illustrated in FIG. 6A to produce the O-shaped bread as illustrated in FIG. 6B and cutting F a middle part.

Breads manufactured by a molding frame 200b having repeated U shapes as illustrated in FIG. 7A and repeating a plurality of U shapes as illustrated in FIG. 7B may be simultaneously produced and used by cutting F required regions. Such a manufacturing method is convenient for mass production.

Accordingly, the present invention is not limited to the aforementioned manufacturing method and may be manufactured by various manufacturing methods within the logic of the present invention.

Accordingly, since the shape of the burger bread which is fixed in the U shape and supported with the shape is maintained without pressing the contents 101 such as vegetables stacked therein, the structure itself is not deformed and stable as it is when sauces and the like are added, thereby maintaining the taste and the flavor of the burger as they are.

Further, since the structure of the U-shaped bread is supported so that the contents 101 such as a patty, vegetables, etc. received in the U-shaped inner surface are not leaked outside, the contents 101 such as ketchup, etc. are not stained on the cloth or around the mouth, so that it is very easy to be taken and it is easy to be taken in vehicles or at offices or home.

The bar-shaped U burger can be taken by a customer by carrying the bread itself, directly selecting the contents 101, and putting the contents 101 in the bread and can be mass-produced in a short time, so that it is very efficient for school meals, etc.

That is, according to the present invention, since the three surfaces of the inner upper surface 4, the inner rear surface 5, and the inner lower surface 6 are supported and protected as the inner surface of the bread itself which is formed and fixed in the U shape, the contents 101 received therein are protected and supported.

Accordingly, one direction of the receiving space d in the bread is opened and the bread is formed and fixed at a height of the receiving space d to stably receive the contents 101 of the burger such as vegetables, meats, and sauces therein, thereby maintaining the flavor and the taste of the bread.

Further, since the inner surface of the bread is supported in three directions of the inner upper, rear, and lower surfaces 4, 5, and 6, the contents 101 such as vegetables, etc. are not deformed, and the contents 101 such as patties, ketchup, sauces, lettuce, etc. in the hamburger are not leaked when eating and not easily stained on the hand or mouth, so that there is no problem of easily contaminating hands, cloth, etc. by falling down on the cloth, which is the problem of the conventional hamburger.

Further, since the structure of the U-shaped burger bread significantly shortens the cooking time, the burger may be rapidly provided at takeaways, drive-through, food trucks, trailer food trucks, etc. while maintaining the taste and the flavor.

Since the above description is illustrative of the present invention, it is characterized the structure of the U-shaped burger bread and the manufacturing method of the burger bread in which three sides consisting of the outer upper, read, and lower surfaces 1, 2, and 3 and the inner upper, read, and lower surfaces 4, 5, and 6 are fixed and elongated in the longitudinal direction. It will be appreciated that the structure of the U-shaped burger bread and the manufacturing method of the present invention can be variously modified by those skilled in the art to which the present invention pertains to cover the scope of the present invention.

1. A manufacturing method for U-shaped burger bread comprising:
step 1 of adding, stirring, mixing, and kneading vegetable flour such as flour as a main ingredient, sugar, milk, salt, yeast, and water in a kneading bowl and aging and primarily fermenting a paste;
step 2 of removing gas in the paste primarily aged and fermented;
step 3 of preparing a molding frame in which an inside for forming and completing the U-shaped bread has a reverse U shape and a bar shape elongated in a longitudinal direction;
step 4 of receiving the paste formed in a rectangular shape in the molding frame to seat the paste removed with the gas on the molding frame;
step 5 of re-fermenting the paste received in the molding frame;
step 6 of completing the U-shaped burger bread by putting and baking the molding frame received with the re-fermented paste in an oven; and
step 7 of separating the completed U-shaped bread from the reverse U-shaped bread frame and cooling the U-shaped bread in a cooling net,
wherein the paste is secondarily fermented, aged, formed and baked in the reverse U-shaped molding frame to be fixed as the U-shaped bread.

2. The manufacturing method for the U-shaped burger bread of claim 1, wherein in order to manufacture the U-shaped bread, based on a cross-sectional shape, a reverse U shape is formed in an inner middle part, and expanding spaces for determining the thickness of the U-shaped bread are formed at left and right of the reverse U-shaped molding frame, and the reverse U-shaped molding frame is manufactured so that heat is introduced from the outside of the reverse U-shaped molding frame.

3. The manufacturing method for the U-shaped burger bread of claim 1, wherein the main ingredient of the U-shaped bread is any one of edible flour such as rice flour or flour and mixed flour in which the edible flour and the rice flour or flour are mixed at an appropriate amount.

4. A U-shaped burger bread manufactured by claim 1.

5. The U-shaped burger bread of claim 1, wherein an inner surface of the U-shaped bread is heated by a heating device which is formed in a reverse U shape corresponding to the inner surface thereof and added with a heating function outside thereof.

6. A U-shaped burger bread, wherein an outside of the bread consists of an upper surface, a rear surface, and a lower surface, and an inside of the bread consists of an inner upper surface, an inner rear surface, and an inner lower surface, so that the entire shape is fixed and formed as thick U-shaped bread,
a receiving space is formed by three sides consisting of the inner upper surface, the inner rear surface, and the inner lower surface of the bread,
the receiving space is elongated in a longitudinal direction with a length twice larger than a width of the bread and one side thereof is opened,
contents of the burger such as meat, vegetables, and sauces are received into the receiving space with the opened one side, and
the contents are stably received into the bread in which the U shape is fixed and maintained and the contents are not in disorder when eating, the taste is maintained, and it is easy to be taken with one hand.
